(19) United States
(12) Patent Application Publication
(10) Pub. No.: US 2002/0036691 A1
(43) Pub. Date: Mar. 28, 2002

(54) Method and system for determining the relative occupancy of a space via analysis of the video stream

(76) Inventor: Richard Alexander Franklin, San Diego, CA (US)

Correspondence Address: Richard A. Franklin, 10944 Salinas Way, San Diego, CA, 92126, US

(21) Appl. No.: 09/916,638

(22) Filed: Jul. 26, 2001

Related U.S. Application Data
(60) Provisional application No. 60/220,740, filed on Jul. 26, 2000.

(51) Int. Cl. H04N 7/18

(52) U.S. Cl. 348/143

(57) ABSTRACT

The present invention relates generally to transactions over a system of networked computers, such as the Internet. More specifically, the present invention relates to novel methods for determining the relative occupancy of a space through analysis of streamed video and or images, over a system of networked computers.

### RELATED APPLICATIONS

This application claims priority from U.S. Provisional Application Ser. No. 60/220,740, filed Jul. 26, 2000, which is incorporated by reference in its entirety.

### FIELD OF THE INVENTION

The present invention relates generally to transactions over a system of networked computers, such as the Internet. More specifically, the present invention relates to novel methods for determining the relative occupancy of a space through analysis of streamed video and or images, over a system of networked computers. The present invention further relates to an open forum acquaintance locator which is specific for states, cities & locations and or venues within the city. ; providing chance meetings a better chance, offering views into city nightlife and activities, delivering information about city & city locations, supplying international access to post and read comments about locations, combined with a real-time view into the general atmosphere of a location

### BACKGROUND OF THE INVENTION

The following description of the background of the invention is provided to aid in understanding the invention, but is not admitted to be or to describe prior art to the invention.

Computer systems in general are known. A typical system comprises a computer, keyboard, mouse, and a monitor. Additionally, the computer comprises a central processing unit (“CPU”) and random access memory (“RAM”) and allows various software programs to be used. Further, the computer might comprise a modern, an Ethernet card or other similar device for connecting to a system of networked computers, such as the Internet.

The Internet provides a useful technique for making information available to a variety of individuals each of whom may be located at a variety of different locations. Indeed, within the vast Internet environment, individuals can access information tools from remote locations.

The Internet, which originally came about in the late 1960s, is a computer network made up of many smaller networks spanning the entire globe. The host computers or networks of computers on the Internet allow public or private access to databases containing information in numerous areas of expertise. Hosts can be sponsored by a wide range of entities including, for example, universities, government organizations, commercial enterprises and private individuals.

Internet information is made available to the public through servers running on an Internet host. The servers make documents or other files available to those accessing the host site. Such files can be stored in databases and on storage media such as, for example, optical or magnetic storage devices, preferably local to the host.

Networking protocols can be used to facilitate communications between the host and a requesting client. TCP/IP (“Transmission Control Protocol/Internet Protocol”) is one such networking protocol. Computers on a TCP/IP network utilize unique identification (“ID”) codes, allowing each computer or host on the Internet to be uniquely identified. Such codes can include an IP (“Internet Protocol”) number or address, and corresponding network and computer names.

Created in 1991, the World-Wide Web (Web, or www) provides access to information on the Internet, allowing a user to navigate Internet resources intuitively, without IP addresses or other specialized knowledge. The Web comprises hundreds of thousands of interconnected “pages”, or documents, which can be displayed on a user's computer monitor. The web pages are provided by hosts running special servers. Software that runs these web servers is relatively simple and is available on a wide range of computer platforms including PC's. Equally available is web browser software, used to display web pages as well as traditional non-web files on the user's system.

The Web is based on the concept of hypertext and a transfer method known as “HTTP” (“Hypertext Transfer Protocol”). HTTP is designed to run primarily over TCP/IP and uses the standard Internet setup, where a server issues the data and a client displays or processes it. One format for information transfer is to create documents using Hypertext Markup Language (“HTML”). HTML pages are made up of standard text as well as formatting codes indicating how to display the page. The browser reads these codes to display the page.

Each web page may contain pictures and sounds in addition to text. Associated with certain text, pictures or sounds are connections, known as hypertext links, to other pages within the same server or even on other computers within the Internet. For example, links may appear as underlined or highlighted words or phrases. Each link is directed to a web page by using a special name called a URL (“Uniform Resource Locator”). URLs enable the browser to go directly to the associated resource, even if it is on another web server.

In addition to the Internet, which allows for general, public retrieval of information, other means of accessing such information exist and are commonly utilized. For example, direct modem connections between two computers, proprietary internal networks within large institutions and organizations, or the like, are equally available and useful means for accessing catalogued information stored in databases.

Some web pages and web sites offer goods for sale. A user can log on the website and purchase such an item. However, such a transaction is not anonymous—the merchant is informed of the identity of the buyer along with personal information about the buyer. Merchants usually require this information to conduct a transaction so that the merchant knows where to ship purchased goods.

Moreover, information regarding users that view or shop at web pages risk having their identity, address, buying habits, or other personal information, stored in databases and/or provided to other third parties, without the user's consent. Merchants obtain this information through the Internet and may sell or provide this information to third parties without consulting the user. Additionally, merchants may retain this information for their own use. Moreover, other parties, such as computer hackers, may also easily obtain a user's personal information from transactions with these merchants. For example, third parties may track where the user shops, where the user made his or her purchase, or which web pages the user visits. Once information concerning the user is entered into data lists or databases, the user's personal or confidential information may be used in numerous undesirable ways. Additionally, the user may receive “spam” mail or other unwanted or obtrusive communications from other parties. Therefore, a need has arisen for a system for conducting anonymous transactions over a system of network computers.

One use of internet pages or web pages is to provide real-time information to users of the Internet. Presently a wealth of real time information can be found on the Internet such as movie times and location, the current weather conditions, current seismologic information, travel conditions for travel via train, plane or automobile, and other similar services. Furthermore, global positioning data and certain information retrievable via cellular or digital wireless telecommunication devices is also available through the Internet via known wireless internet protocols.

### SUMMARY OF THE INVENTION

The present invention provides methods and configurations of computer hardware and software to provide a national/international web community segregated into categories such as countries states and major cities. Within each city category, popular locations such as restaurants, bars, nightclubs, beaches, malls, theaters, museums, zoos, colleges & universities, and the like are also categorized. An embodiment of the present invention is the creation of an online complex that provides information regarding particular user selected locations of interest and remind or contact a user of the system regarding information relating to a city venue and/or event. Simultaneously, the present invention provides an internet site and dynamic database that can foster a community of people who have “met and missed” the opportunity to discuss and converse with each other.

Thus, the present invention provides a method for two or more people to locate each other either again or for the first time, by use of an automated user information post-based search engine.

The invention provides popular city, neighborhood and venue information categorized via Internet pages stored and catalogued in a network database. On each venue website and/or Internet page allows a user of the invention system to:

Post SEEK ads, -small comments similar, but not limited to the posts in Example A.

View streamed video of the venue, view occupancy/capacity information.

Read other posted SEEK ads.

View venue-updated information regarding upcoming events.

Indicate if they are interested in being updated about events, venue current capacity/occupancy, music selection, menu, daily food specials, bands, DJs, special shows, with regard to the venue via email or wireless web devices such as beepers, pagers, cellular phones, digital phones and other like wireless internet communication devices.

Add the venue to a list of favorite user places.

Receive user contact information in reference to a SEEK ad.

Search SEEK ads.

Post comments/reviews of a particular venue.

In another embodiment, the present invention system will not require membership fees for general usage of the system. Methods for joining websites and performing secure commerce related transactions are known by those of ordinary skill in the art. In following it is also a common practice to have free memberships in order to access certain areas of internet pages. Generally, free memberships require users to provide information about themselves such as for example, age, gender, income and/or education level, particular hobbies and other interest, as well as contact information in order to provide the user with updates or information for which the user has selected to be informed. The present invention allows such members/users to select when they have been located by another user due to both members being at a particular location during the same time as well as select information relating to the relative occupancy of a chosen location.

In another aspect, the present invention provides a system and method for determining the relative occupancy of a particular space, location, or venue, through the inventions systems analysis of a video signal that is transferred from a particular location, space and/or venue to a computer that is connected to a network of computers and further providing such occupancy information to a user via an internet address, an email, or through wireless internet devices. The video signal can be an analog signal that is passed through a video camera to a video card or video processor connected to a computer, or the video signal can be a digital signal which is passed to a computer via similar channels. It is known by one of skill in the art how to attach a video camera to a computer via graphics and/or video capture cards, it is also know that certain boards and/or cards are available that can be connected to a computer processor via motherboards and the like, for display and interpretation of images captured, or ‘picked up’ by a video camera source. The location and type of video camera is not limiting to the present invention as any camera capable of picking up, capturing image information and transferring such information, electronically, to a computer or Central Processing Unit source is capable of functioning within the present invention, as the image capture source and the cards or boards for interpreting such captured information are well known and all models provide information useful in aspects of the present invention.

Logins/passwords will also be given to users who wish to place and check, edit, update, a SEEK ad, or post comments about a particular location. Through logins we will be able to track user access in order to provide information which may prove to be valuable to local and national businesses, cities, and other locations. This information will help us provide clients and potential clients with colorful breakdowns of their clientele and potential.

### DETAILED DESCRIPTION

The present invention allows a user a user access to a network of database stored network available information regarding cities and locations within the cities. The information can be related to the type of entertainment the location provides, the type of food provided by the location, the relative occupancy of the location, the amount or number of cars (traffic conditions) of a location, and further provides a user with methods to configure the system to provide said user with emailed information related to a user selected location or locations.

As used herein the terms “space”, “location” and “venue” are used interchangeably and refer to city attractions such as restaurants, bars, street locations, highways, bridges or tunnels, beaches, city parks and zoos, art museums and the like. Generally a venue or location is a place in a city that is visited by a user of the system, or is a location that a user of the system would like to visit in a city where they may or may not have visited. Most importantly a space or location of the invention is a place where a video camera source of the invention has been installed in order to obtain, capture, take pictures and/or videos of the particular location.

The term “relative occupancy” as used herein, refers to the number of people or automobiles (if the location is a street, highway, tunnel, bridge or parking lot) who are present at a particular location. By relative occupancy is meant the present invention is not concerned with determine the exact number of people or cars in a particular location at a particular time. While the determination of the exact number of people or cars, or other items, is possible using the methods of the present invention, it is preferred to relate to the occupancy of a particular space based on the relative number of people and not the exact number. For example, a particular restaurant location with a maximum real occupancy of 150 people, would be considered in the present invention to be relatively full, or have a relative occupancy of ‘full’ if the number of people in the restaurant exceeds 130 people. In another explanation of the term “relative occupancy” it would be understood by one of skill in the art that several cameras could be placed in various areas of a venue, however the occupants of the venue may not be accounted for by every camera, thus the occupancy information will be relative to the locations of the video cameras. For example, a nightclub might have a dance floor that most users are concerned about with regard to the nightclubs occupancy. A video camera that monitors the dance floor can provide relative occupancy information about the nightclub via observation of the dance floor, however the exact number of occupants could not be determined for the entire venue. Thus, the occupancy is relative to the location the camera is viewing.

The invention system user will generally be an individual who searching for entertainment locations, register to be reminded/contacted regarding a locations attributes, such as music, occupancy, menu and the like, or has accessed the system in order to determine relative occupancy information such as road travel conditions relating to the number of cars at a particular intersection or traversing a particularly busy location such as bridges and tunnels, or relative occupancy information of a particular restaurant, bar or nightclub. The system user can also access a user database portion of the system to search and/or post SEEK ads as well as post comments relating to a particular location.

The phrase “SEEK ads” as used herein refers to user submitted information about themselves and about someone they might have seen at a particular location. The method of posting information to a website is known by those of skill in the art and the type of scripts or posting methods used are not limiting to the present invention. However, the concept of providing an internet location that is connected to a database of city locations that also provides user the ability to post information relating to themselves and a person they have seen in the

location is novel and considered part of the system of the invention. (see Example 1) Upon access to the system via a computer directly linked to the internet via a modem, T1 line, cable and the like, a system user can provide a location/venue name and submit their seek ad. Once a location is provided the user will automatically be taken to the webspace for the location which will provide information relating to the location such as the type of entertainment or food, and the time of day the location is known to be crowded or empty. Once a location is provided by a user which does not already have webspace a general page will be generated indicating that the system will update the information at a later time. Such automated generation of plain text webpages is known by those of ordinary skill in the art and can be performed by server related software that can be purchased at various locations. By being allowed to add a location to the system of the invention, the present invention improves the user experience by being a dynamic internet site that is updated by the users to accommodate the location and provide occupancy information about locations which may not be part of the database. Once a new location is provided a video camera is installed and information relating to the location is obtained through discussions with the proprietor of the location or the city government if the location is a public street, bridge, tunnel and the like. Thus the present invention provides a dynamic, updateable, method for determining the relative occupancy information and other information about a particular location as provided by a user.

An embodiment of the present invention is to provide an internet site/network which allows users real-time, up to date information about a location, by providing a live video stream, a downloadable or saved video stream from a recent evening, and/or venue updated information. Furthermore, our the present invention provides wireless-web information to users who select to receive updates via email, on a computer or wireless devices such as cellular phones, digital phones and alphanumeric messages. In a second aspect individuals who have only spoken through body language (a smile across a room, a wave, an amicable glance), or, who have managed to meet a person and had fin while interacting but forgot to and exchange contact information, can try to relocate someone via the system of the invention. The invention provides a user a chance to post a message which indicates a day, time, location, event, etc. which can be further expanded by others who were at the same location and may know the user or the person the user is trying to find.

The system of the invention can function through the use of streamed video that can be turned on and off by a venue owner/proprietor or by the local government, or sample video clips which a user can download and view. Streaming video from a location via the internet is a technology known by those of ordinary skill in the art and generally requires a video camera source of some sort at a location, connected to a computer and/or video card source that can interpret the video information and prepare it for transport via the internet to remote computers that access the video stream.

The present invention provides a method to search Seek ads that are posted on a particular locations website within the database of the invention. The seek ads are searched via a proprietary server based search engine which specifically searches for characterizations/adjectives within the posts which are similar. A database of such characterizations/adjectives can be expanded as users provide additional definitive terms. For instance, the post in Example I as placed by a man from Chicago would be automatically initiate a search for other postings for the location: Frank's Diner for words such as blonde and black hair, female, New York Times, coffee and tea. Simultaneously, the post would become searchable for key descriptive words as well. Thus the present invention provides instant feedback to users who post SEEK ads. Once an ad is placed, a search of any posts is automatically initiated by the system once the user types in their password and indicates that the SEEK ad is correct. This searching utility can provide a user incentive to view the system's site to periodically to check to see if their post has information that has been disclosed in another users post. This advantage is not offered by newspapers where you must read every post in order to determine if someone is trying to locate you. Likewise, other “personals” sites do not offer an automatic searching method to help a person locate an ad that has already been placed that may contain information and/or words similar to what is posted.

This unique combination of websites and services, of the present invention can follow both web-traditional and entertainment-traditional means for generating revenue via the internet. Due to the specific content of the systems site, businesses, international merchants, public facilities such as museums, and even city governments can find reasons to purchase online advertising. Ad placement (top of page, middle of page, separate opening windows) can account for varying prices for businesses and multiple ads will also be an option. Furthermore, the anonymous user data we receive over time should help in deciding locations within the systems site to post advertisements. Popular cities and locations will have higher priced advertisement rates due to the additional number of users who will view the ads. Furthermore, front page advertising, while kept at a minimum will also cost more than ads directly placed within the website.

Additionally, EyeAds -multimedia, Shockwave flash™ and the like, based web-advertisements streamlined for quick download and presentation— can be offered for businesses for additional charges. These ads can be made using available purchased software and created in a direct attempt to give the user an interesting animated advertisement for the merchants product or business entity.

The present invention system and methods provide the following additions the internet:

Itemized Locations-Creating an online environment which showcases a nations cities and highlights locations within each city. The system can comprise web pages for cities and the respective businesses and attractions and locations within the city. Webspaces which contain streaming video, sound bytes and photos of popular venues, thereby providing a method for entertainment venues to provide potential clientele with dynamically updated information in real-time (video streaming, occupancy indications and the like) via the internet and wireless devices such as wireless-web telephones, beepers and other like devices.

Virtually Real Entertainment-Through our use of SEEK ads and comment posting, the present invention can chronicle the events which occur in a cities various locations and attractions. The continued use of our website can provide a local business a method to further their commercial appeal through “tie-ins” with online content. Furthermore, the anonymous aspect of the internet can offer users a chance to indirectly influence the atmosphere of the business location.

Targeted Advertising-By collecting user information, the inventions system aids cities and local business in understanding who is being attracted to various events and attractions in order to either expand the user market or determine what type of action needs to be taken to expand the customer market.

Patron & Business Advancement-Offering citywide businesses, populations and attractions a location where they are selected and found by patrons (system users) will help to bring businesses, people and/or attractions to the internet where they may have never considered being part of the internet before.

As a member of the system database, an establishment can be allotted a web page and server space which can be updated regarding current events. Managers/Owners of such establishments can be provided with a secure login environment to be accessed from a computer terminal Once logged in the owner will be prompted to enter an update current events area wherein events can be submitted for display on the webspace. One manner in which this can be accomplished is by providing a space within the internet browser readabe document which takes posted/added information regarding the upcoming events from the manager/owner. This information is then placed on the public/user accessed webpages by an automated computer software driven source. Updating web page posts is a common event carried out by many websites however, providing such access to entertainment venues for the purpose of providing a public notation of an event is not currently available on a database internet source.

In another aspect, the present invention provides both online (emailed or provided as a user logs on) or wireless internet (through the use oftechnologies such as hand held alpha numeric devices/beepers or cellular phones, electronic personal organizers) information regarding a clubs nightly music genre/entertainment, food specials, and relative occupancy. Occupancy information is provided to allow a user to decide if the venue of choice, city location, public road or highway, has reached a point at which the number of people or cars is either large enough or small enough for the users particular taste and interest. In a nonlimiting example a high relative occupancy output at a nightclub may indicate that the nightclub is enjoying a good night and a user of the system may decide that is what they were looking for. In another example, a particular area of a highway, freeway or public street may be monitored and provide relative occupancy information that indicates that there are too many cars traveling on the road at the particular time and result in the user finding a different rout. Such information will be transmitted via commonly used and well understood means, such as email, and wireless communication devices.

Occupancy determinations will not be indicative of local Fire Code regulations for maximum capacity or occupancy. In one aspect, occupancy will be determined, locally via employees at the door, or those whose responsibility it is to make sure the venue is within a certain occupancy limit. These individuals will have the opportunity to either use a computer terminal to transmit such data to our servers where it is then transmitted to users who have signed up to be contacted, or by users who happen to be viewing the website, i.e. the occupancy information is updated in real-time on the internet.

In another embodiment, relative occupancy information is gathered using novel invention related technology which uses the first, first 1-1000, 1-500, 1-250, 1-100, 1-50, or 1-10, frames of captured video, a base standard to which later images are digitally compared. One of skill in the art would readily recognize that digital images such as streamed video, still pictures and the like are comprised of data/numeric, alpha numeric indications which are translated and shown on a computer screen as an image. Such information can be used in comparisons to determine how the image changes as a venue becomes crowded, more full or empty of people or cars for example. In a non limiting example particular areas within a nightclub can be chosen to have a video camera place in a manner that allows the location image to be captured analyzed via the invention computer program to determine baseline data points which represent an empty nightclub/venue. As the nightclub becomes more full with patrons, these video monitored areas will change in values as more people enter the monitored areas. As more people or cars enter the monitored area the image that is captured changes and the changes are represented by numbers, data, alphanumeric charactersets that can be compared to the original, baseline, image that was captured when the location was relatively empty. The changes in values of the images are representative of locations within the frame of video or within the picture which are darker or lighter as a result of patrons clothing, hair, bodies and the like, which were not present when the baseline image(s) were captured. These number changes are then compared to the baseline values calculated when the club is less full or empty, and provide a determination of the nightclub/venues relative occupancy.

Thus the present invention provides a method for determining the relative occupancy of a space via analysis of a video stream, where the space can be a restaurant, a nightclub, a bar, a highway, a freeway, a beach, a tunnel, a bridge, or a public park.

In another embodiment the present invention provides a computer system for determining the relative occupancy of a space where the computer system comprises a network computer or system of networked computers that are connected to the internet. The computer system is connected to a computer having a video card, or the computer system comprises a video card or graphics card for capturing/obtaining video information as provided by a video camera that is connected to the system. The system comprises a software program that functions on the computer system of the invention, where the program either functions as a server software service (working for all computers of the system that are interconnected) or the software functions on each machine individually, due the type of graphics/video capture card that is part of the particular computer. One of skill in the art would readily understand that the API for one graphics card can be different from one card to another, however all graphics and capture cards have protocols for accessing the information provided by the video camera and preparing the information for visualization on a monitor (computer monitor, TV monitor and the like). The system software program is for analysis of the video stream as it is obtained from the video capture source and the software program creates data to represent a baseline image which represent an empty location, and creates data for later images that are obtained/captured by the video source where the data is compared to the baseline data in order to determine the change in image composition in order to obtain relative data information. The system can also comprise an internet location for providing said relative occupancy information to the public, via email, the internet or wireless web devices..

An occupancy meter, an indicator (such as an empty bar—a vector four sided rectangle—which becomes full, or a pie chart which begins empty and becomes full) on the invention systems webspace/webpage can then allow a person/user to determine if they feel the venue has the number of patrons which is desired, for example an empty nightclub may not be as interesting as a full nightclub or a fill restaurant may not be as romantic as an empty nighclub. Such information is then sent by automated means to either email recipients or wireless web recipients. Locations within the venue will be selected with aid from the proprietor based on the information they have gained during their proprietorship of the venue, for example, a dance club owner will be able to indicate regions of a dance floor which represent a full house and a restaurant owner will be able to indicate areas which generally become full during a good evening. Such information can also be valuable to larger locations such as airports, zoos, museums, beaches, neighborhoods to determine occupancy.

In obtaining and determining the occupancy information it is important that one of skill in the art obtain the proper API protocol for the video card/capture board that is used to interpret the information sent from the video source. Within the API it is known that there are lines of code and particular aspects of the protocol that determine the type of image that is being saved/converted for viewing via a computer. For example a particular video capture card or video capture device may interpret video information and prepare the information as avi, mpeg, ram, jpg, tga, or other digital file formats before the information is viewable on the computer screen. It is an aspect of this invention that the information collected to determine the relative occupancy levels can be accessed at the interface between showing the information as a visual image on the computer screen and obtaining the information via the video card. The current inventions program, and programs that would be similar, make use of the particular video cards API protocol, and use the digital image information at this point to create the baseline, and changes in image information as described above. Dissimilar yet useful methods using the same concepts are known by those in the art. For example, researchers have used the motions of people in a crowd as captured by a video camera to manipulate objects projected on a video monitor connected to a computer. In doing so, the information that is captured by the video camera is interpreted for information relating to the pixels of the digital images that are processed by the graphics card, and used to manipulate the way an object behaves on a computer screen. Thus, the use of the interface between the graphics card and other programs on a computer is not new in the art, however the concept of accessing the image information and creating a baseline image to which later images are compared in order to determine relative occupancy information is new to the art and a preferred embodiment of the present invention. As a result, it is possible to determine the relative occupancy of a space by analysis of a video stream without having to save the video stream or show the video stream, which is advantageous to nightclubs, restaurants and city governments who do not want to be accused of watching the individual patrons and citizens, but do want to provide a useful service.

### EXAMPLE 1 SEEK ad Posts

post Male—female Chicago, Ill. ‘You, with black hair and blonde friend (female), sitting drinking coffee and tea, reading a New York times about two weeks ago (roughly 0/0/00) at Frank's diner. ‘Me, smiled at you holding a briefcase wearing high top tennis shoes. I had to leave and get to work but would like to get a chance to say hello. Please contact via site —no picture provided—

post Female-male—Tampa Bay, Fla. ‘Me jogging along boardwalk, blue shorts, black hair -ponytail-, near taco place, tying my shoes. ‘You with friends (a few guys) getting out of a car with surfboard and wetsuits (I think black orange stripes). Heard you mention an idea and may be able to help you with some of the groundwork please contact via site —no picture provided—

### EXAMPLE II Comment Posts

post Female-male—Tampa Bay, Fla. If you have not been to the Chicago zoo lately, you are missing a wonderful experience.

post Male, 26 yr—Atlanta, Ga. For all of you at THE CLUB last night, Feb. 24, 2000, thanks for being there, I had the most fun I have ever had on my birthday.

post Female, 30 yr Mar. 1, 2000 -Washington, D.C.

;), Again!!!, THE CLUB, helped prove there is only one place in town to hear good music by a live band and dance!!!

We Claim:

1. A method for determining the relative occupancy of a space via analysis of a video stream.

2. The method of claim 1, wherein the space is one of a restaurant, a nightclub, a bar, a highway, a freeway, a beach, a tunnel, a bridge, or a public park.

3. A computer system for determining the relative occupancy of a space comprising:
a network computer system connected to the internet and comprising a connection to or having connected thereto a graphics card for capturing a video stream,
a camera for providing said video stream,
a software program for analizing said video stream and determining a baseline image or sequence of images thereby providing relative occupancy information,
an internet location for providing said relative occupancy information to the public.
